(19) United States
(12) Patent Application Publication
(10) Pub. No.: US 2010/0252453 A1
(43) Pub. Date: Oct. 7, 2010

(54) CONTROL SOLUTION FOR DETERMINING PERFORMANCE OF ELECTROCHEMICAL SENSING SYSTEM AND METHOD FOR THE SAME

(75) Inventors: Kai-Tsung TENG, Hsinchu City (TW); Chien-Chuan LIN, Hsinchu City (TW); Shih-Chang WANG, Hsinchu City (TW); Yueh-Hui LIN, Hsinchu City (TW); Thomas Y.S. SHEN, Hsinchu City (TW)

Correspondence Address: LIU & LIU, 444 S. FLOWER STREET SUITE 1750, LOS ANGELES, CA, 90071, US

(73) Assignee: APEX BIOTECHNOLOGY CORP., Hsinchu City (TW)

(21) Appl. No.: 12/751,345

(22) Filed: Mar. 31, 2010

(30) Foreign Application Priority Data
Apr. 1, 2009 (TW) 98110836

(51) Int. Cl. G01N 27/416; G01N 27/26

(52) U.S. Cl. 205/792; 204/403.01

(57) ABSTRACT

A control solution for determining the performance of an electrochemical sensing system for measuring the concentration of an analyte in a body fluid sample and methods using the same are provided. The control solution contains the analyte at a predetermined amount and an alcohol-containing adjustor. The control solution generates a current signal from the electrochemical sensing system when the performance of the electrochemical sensing system is qualified and obtains a measured concentration corresponding to the current signal, wherein the measured concentration is less than the real concentration corresponding to the predetermined amount.

### CROSS REFERENCE TO RELATED APPLICATIONS

This application claims the right of priority based on Taiwan Patent Application No. 98110836 entitled “CONTROL SOLUTION FOR DETERMINING PERFORMANCE OF ELECTROCHEMICAL SENSING SYSTEM AND METHOD FOR THE SAME”, filed on Apr. 1, 2009, which is incorporated herein by reference and assigned to the assignee herein.

### FIELD OF THE INVENTION

The present invention relates to a control solution for and a method of testing the performance of an electrochemical sensing system, in particular to a control solution for the quantification of an analyst in a body fluid using an electrochemical sensing system.

### BACKGROUND OF THE INVENTION

In a conventional electrochemical sensing system, a so-called “control solution” or “standard solution” is used to verify the performance of the electrochemical sensing system. For example, the control solution is commonly equipped with a home sensing system of blood glucose so that the user can verify the accuracy of the system by determining whether the test strip and the meter are working properly. Therefore, quality of the control solution concerns whether the performance of the electrochemical sensing system is determined accurately.

In comparison to a blood sample, a conventional control solution without blood cell normally exhibits a higher reaction magnitude due to their significant different physical properties. For a conventional control solution, the measured concentration of glucose obtained from an electrochemical system is around 1.2 to 2.5 times of its real concentration of glucose. Specifically, when applying a control solution having an a real concentration of glucose around between 30 mg/dL and 120 mg/dL to an electrochemical system, the qualified measured concentration is ranged from around between 50 mg/dL and 250 mg/dL.

However, real concentration of the glucose in the control solution may alter due to environmental factors. For example, a careless operator may cause an enzyme from a test strip to contaminate the control solution. The enzyme may gradually reduce the glucose amount in the control solution even if the contamination level is a trace. This will result in a wrong determination to the performance of the electrochemical system when the contaminated control solution is applied to the system.

### SUMMARY OF THE INVENTION

In order to obviate the previously mentioned drawbacks, one aspect of the present invention is to provide a control solution having an alcohol-containing adjustor; a related sensing system; and a testing method thereof. Compared with the conventional control solution, the control solution of the aspect of the present invention generates a lower reaction magnitude when it is applied to a qualified electrochemical system. With the lower reaction magnitude for the control solution of the present invention, the reaction interference resulted from the contaminant is reduced. The control solution of the present invention generates a measured concentration of analyst from the electrochemical system lower than the real concentration of analyst in the control solution. Further in accordance with one aspect of the present invention, a control solution may contain an analyst in a higher amount compared with the conventional control solution. As having a higher amount of the analyte, compared with the conventional control solution with a contaminant, the present invention provides a control solution exhibiting less measured concentration loss when it contains the same amount of the contaminant. This reduces the opportunity of making a wrong determination toward the performance of the electrochemical sensing system.

In one embodiment, the present invention provides a control solution for determining the performance of an electrochemical sensing system, the electrochemical sensing system being adapted for measuring the concentration of an analyte in a body fluid sample, the control solution comprising the analyte at a predetermined amount; and an alcohol-containing adjustor, wherein the control solution generates a current signal from the electrochemical sensing system when the performance of the electrochemical sensing system is qualified and obtains a measured concentration corresponding to the current signal, wherein the measured concentration is less than a real concentration corresponding to the predetermined amount.

In another embodiment, the present invention provides a control solution similar to the aforementioned, wherein the electrochemical sensing system is adapted for a normal control solution having the analyte but not having the alcohol-containing adjustor, and the normal control solution generates a normal current signal in the electrochemical sensing system when the performance of the electrochemical sensing system is qualified, wherein when the control solution and the normal control solution respectively contain the same predetermined amount of a contaminant, the magnitude of the current signal for the control solution is lower than the magnitude of the normal current signal for the normal control solution.

In further another embodiment, the present invention provides an electrochemical sensing system for measuring the concentration of an analyte in a body fluid sample, the electrochemical system comprising a test strip; a measuring device; and a control solution similar to the aforementioned for determining the performance of the electrochemical sensing system.

In still another embodiment, the present invention provides a method for determining the performance of an electrochemical sensing system for measuring the concentration of an analyte in a body fluid sample, the electrochemical system comprising a test strip; a measuring device; and a control solution having an analyte at a predetermined amount and an alcohol-containing adjustor, the method comprising: connecting the test strip to the measuring device; generating a current signal and a measured concentration corresponding to the current signal from the measuring device by contacting the control solution with a reaction reagent on the test strip; and determining that the electrochemical sensing system is qualified if the measuring concentration is within a standard range for the electrochemical sensing system, or determining that the electrochemical sensing system is unqualified if the measuring concentration is out of the standard range.

### BRIEF DESCRIPTION OF THE DRAWINGS

FIG. 1 depicts a current profile from the performance qualified electrochemical system showing the reaction magnitudes in association with every control solution of Example 2A.

FIGS. 2 and 3 respectively depicts a current profile from the performance qualified electrochemical system showing the reaction magnitudes in association with every control solution of Examples 2B and 2C.

FIG. 4 depicts a table showing the resulted data of the Example 3.

### DETAILED DESCRIPTION OF THE INVENTION

The present invention may best be understood by reference to the following description in conjunction with the accompanying drawings, in which similar reference numbers represent similar elements. Any devices, components, materials, and steps described in the embodiments are only for illustration and not intended to limit the scope of the present invention. It should be noted that the features illustrated in the drawings are not necessarily drawn to scale. Descriptions of well-known components, materials, and process techniques are omitted so as not to unnecessarily obscure the embodiments of the invention.

In one embodiment, the present invention provides an electrochemical sensing system being adapted for measuring the concentration of an analyte in a body fluid sample. The electrochemical sensing system includes a test strip, a measuring device and a control solution. The technology with respect to the test strip and the measuring device is fully described in U.S. patent application Ser. No. 11/640,886, which is incorporated herein by reference. The analyte adapted for the electrochemical sensing system is a kind of biomaterial from the body fluid, for example, glucose, cholesterol, lactic acid, or triglyceride.

The control solution provided herein is for determining the performance of the electrochemical sensing system. In the embodiment, ingredients of the control solution includes, but not limited to, the analyte at a predetermined amount and an alcohol-containing adjustor. The control solution generates a current signal from the electrochemical sensing system when the performance of the electrochemical sensing system is qualified and obtains a measured concentration corresponding to the current signal, wherein the measured concentration is less than a real concentration corresponding to the predetermined amount. In other words, one concept in associated with the embodiment is to provide a control solution, which can generate a measured concentration from the electrochemical sensing system, wherein the measured concentration is lower than the real concentration corresponding to the predetermined amount of the analyte. With the lower measured concentration, the reaction interference resulted from a contaminant in the control solution is reduced.

Another concept in associated with the embodiment is to provide a control solution having a predetermined amount of the analyte higher than a normal predetermined amount of the analyte in the conventional control solution. In such a way, the reaction interference resulted from the contaminant in the control solution is reduced compared with the conventional control solution. For example, in a condition where the control solution of the present invention and the conventional control solution respectively contain the same amount of a contaminant (e.g. an enzyme), they will lost the same amount of the analyst for a period of time in the presence of the contaminant. However, as the control solution of the present invention contains a higher predetermined amount of the analyte, it relatively suffers from a less real concentration loss of analyte compared with the conventional control solution. Similarly, the measured concentration loss of analyte for the control solution of the present invention is relatively less in comparison to the conventional control solution. In such a way, by using the control solution of the present invention, the opportunity of making a wrong determination regarding the performance of the electrochemical sensing system is decreased. Consequently, the control solution of the present invention will be very useful for the whole blood sensing system application.

The alcohol-containing adjustor of the present invention comprises primary alcohol, secondary alcohol, or tertiary alcohol. The alcohol-containing adjustor having enough polarity to dissolve in a water medium is preferred. For the classification of primary alcohol, methanol, ethanol or propanol are preferred. The more preferred is ethanol, wherein the concentration is ranged between 100 ml and 500 ml based on per liter of the control solution. For the classification of polyalcohol, glycerol, polyethylene glycol and isopropanol are preferred, wherein the more preferred are glycerol and polyethylene glycol. The preferred concentration of glycerol is ranged between 100 ml and 500 ml based on per liter of the control solution. The preferred concentration of polyethylene glycol is ranged between 100 g and 500 g based on per liter of the control solution. For the classification of secondary alcohol, isopropanol, 2-butyl alcohol, and 2-amyl alcohol are preferred, wherein the more preferred is isopropanol. The preferred concentration of isopropanol is ranged between 100 ml and 500 ml based on per liter of the control solution. In another embodiment of the present invention, the alcohol-containing adjustor comprises any combination of the aforementioned ingredients.

In accordance with one embodiment of the present invention, the control solution is considerably stable and non-toxic instantly by touching. The control solution contains other ingredients such as a solvent, a buffer salt, a signal mediator and a preservative. The solvent can be any suitable chemical including water but not limited there to. The buffer salt can be citrate or phosphate but not limited there to. The signal mediator can be any suitable chemical such as potassium ferricyanide but not limited there to. The preservative can be any suitable chemical such as sodium benzoate but not limited there to. Examples of the control solution according to one embodiment of the present invention are listed as below:

| | | |
|---|---|---|
| Glucose (i.e. the analyte) | 200 | mg/dL |
| Citrate | 10 | g/L |
| Potassium ferricyanide | 100 | g/L |
| Sodium benzoate | 5 | g/L |
| Ethanol (i.e. alcohol-containing adjuster) | 200 | ml/L |

| | | |
|---|---|---|
| Glucose (i.e. the analyte) | 160 | mg/dL |
| Citrate | 10 | g/L |
| Potassium ferricyanide | 100 | g/L |
| Sodium benzoate | 5 | g/L |
| Isopropanol (i.e. alcohol-containing adjuster) | 200 | ml/L |

| | | |
|---|---|---|
| Glucose (i.e. the analyte) | 200 | mg/dL |
| Citrate | 10 | g/L |
| Potassium ferricyanide | 100 | g/L |
| Sodium benzoate | 5 | g/L |
| Glycerol (i.e. alcohol-containing adjuster) | 200 | ml/L |

| | | |
|---|---|---|
| Glucose (i.e. the analyte) | 200 | mg/dL |
| Citrate | 10 | g/L |
| Potassium ferricyanide | 100 | g/L |
| Sodium benzoate | 5 | g/L |
| polyethylene glycol (i.e. alcohol-containing adjuster) | 250 | ml/L |

In accordance with one embodiment, the method of the present invention for determining the performance of an electrochemical sensing system is substantially similar to the conventional electrochemical system, such as typical measuring system of blood glucose, in addition to the control solution as aforementioned. Briefly speaking, the method comprises the steps of:

connecting the test strip to the measuring device;
generating a current signal and a measured concentration corresponding to the current signal from the measuring device by contacting the control solution with a reaction reagent on the test strip; and
determining that the electrochemical sensing system is qualified if the measuring concentration is within a standard range for the electrochemical sensing system, or determining that the electrochemical sensing system is unqualified if the measuring concentration is out of the standard range.

Note that the reaction reagent on the test strip can vary depending upon the differences of the analyte. For example, as for the glucose analyte, the reagent may contain glucose oxidase (i.e. GOD or GOX) or glucose dehydrogenase; as for the lactic acid analyte, the reagent may contain lactate dehydrogenase; as for the cholesterol analyte, the reagent may contain cholesterol esterase or cholesterol oxidase. Other components on the test strip are the signal mediator potassium ferricyanide or citric acid or potassium phorphate, etc.

### Example 2A

### Glucose Control Solution

Measuring device: PalmSens.

Test strip: the analyte is glucose (GlucoSure Star)

The normal control solution: CONTREX
PLUS (i.e. the conventional)

| | |
|---|---|
| L1 | Lower glucose amount: the real concentration of glucose: 50 mg/dL, |
| | with buffer salt (i.e. citric acid and potassium phosphate) at an |
| | adequate amount. |
| | The standard measured concentration is ranged at: 110 mg/dL ± 20% |
| | (i.e. between 88 mg/dL and 132 mg/dL) according to ISO 15197 |
| | Requirement. |
| L2 | Higher glucose amount: the real concentration of glucose: 160 mg/dL, |
| | with buffer salt (i.e. citric acid and potassium phosphate) at an |
| | adequate amount. |
| | The standard measured concentration is ranged at: 240 mg/dL ± 20% |
| | (i.e. between 192 mg/dL and 288 mg/dL) according to ISO 15197 |
| | Requirement. |

The control solution of the present invention

| | |
|---|---|
| A1 | The real concentration of glucose: 160 mg/dL, with glycerol 50 wt % |
| | (i.e. alcohol-containing adjuster) and other ingredients at an |
| | adequate amount. |
| | The standard measured concentration is ranged at: 110 mg/dL ± 20% |
| | (i.e. between 88 mg/dL and 132 mg/dL) according to ISO 15197 |
| | Requirement. |
| A2 | The real concentration of glucose: 370 mg/dL, with glycerol 50 wt % |
| | (i.e. alcohol-containing adjuster) and other ingredients at an |
| | adequate amount. |
| | The standard measured concentration is ranged at: 240 mg/dL ± 20% |
| | (i.e. between 192 mg/dL and 288 mg/dL) according to ISO 15197 |
| | Requirement. |

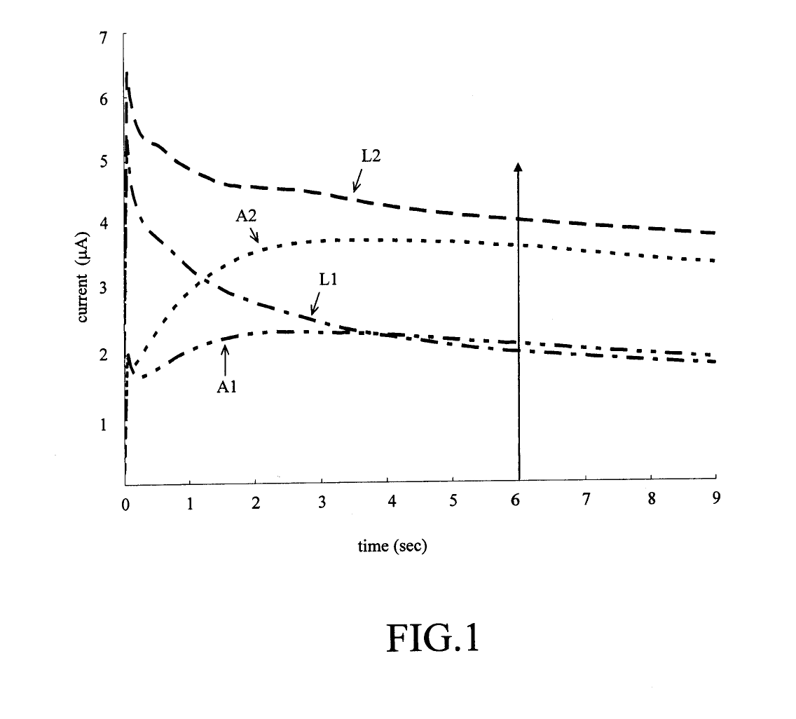

FIG. 1 depicts a current profile from the performance qualified electrochemical system showing the reaction magnitudes in association with every control solution of Example 2A. The curve L1 represents the conventional control solution (L1) having the lower glucose amount. The curve L2 represents the conventional control solution (L2) having the higher glucose amount. The curve A1 represents the control solution (A1) of the present invention with the glucose amount 160 mg/dL the same as the conventional control solution (L2). As shown in FIG. 1, the curve L1 nearly approaches the curve A1. In other words, based on the same electrochemical sensing system, the control solution A1 of the present invention with a glucose amount up to 160 mg/dL generates a standard measured concentration range between 88 mg/dL and 132 mg/dL, and the range is the same as that generated from the conventional control solution L1 with a lower glucose amount (i.e. 50 mg/dL). In other words, the control solution (A1) with a higher glucose amount creates an effect that was supposed to be done by the conventional control solution L1 with a lower glucose amount. This indicates that the control solution A1 is capable of reducing the reaction magnitude compared with the conventional control solution. This also indicates that the measured concentration is no longer higher than the real concentration. For the control solution A1, the measured concentration (i.e. between 88 mg/dL and 132 mg/dL) is lower than the real concentration (160 mg/dL).

### Example 2B

### Cholesterol Control Solution

Measuring device: PalmSens.

Test strip: the analyte is cholesterol (cholSure)

The normal control solution: cholSure (i.e. the conventional)

| | |
|---|---|
| L3 | The real concentration of cholesterol: 12.5 mg/dL, with buffer |
| | salt (i.e. citric acid and potassium phosphate) at an adequate amount. |

The control solution of the present invention

| | |
|---|---|
| A3 | The real concentration of cholesterol: 12.5 mg/dL, with glycerol |
| | 50 wt % (i.e. alcohol-containing adjuster) and buffer salt (i.e. |
| | citric acid and potassium phosphate) at an adequate amount. |

### Example 2C

### Lactic Acid Control Solution

Measuring device: PalmSens.

Test strip: the analyte is lactic acid (THE EDGE)

The normal control solution: THE EDGE (i.e. the conventional)

| | |
|---|---|
| L4 | The real concentration of lactic acid: 50 mg/dL, with buffer salt |
| | (i.e. citric acid and potassium phosphate) at an adequate amount. |

The control solution of the present invention

| | |
|---|---|
| A4 | The real concentration of lactic acid: 50 mg/dL, with glycerol |
| | 50 wt % (i.e. alcohol-containing adjuster) and buffer salt (i.e. |
| | citric acid and potassium phosphate) at an adequate amount. |

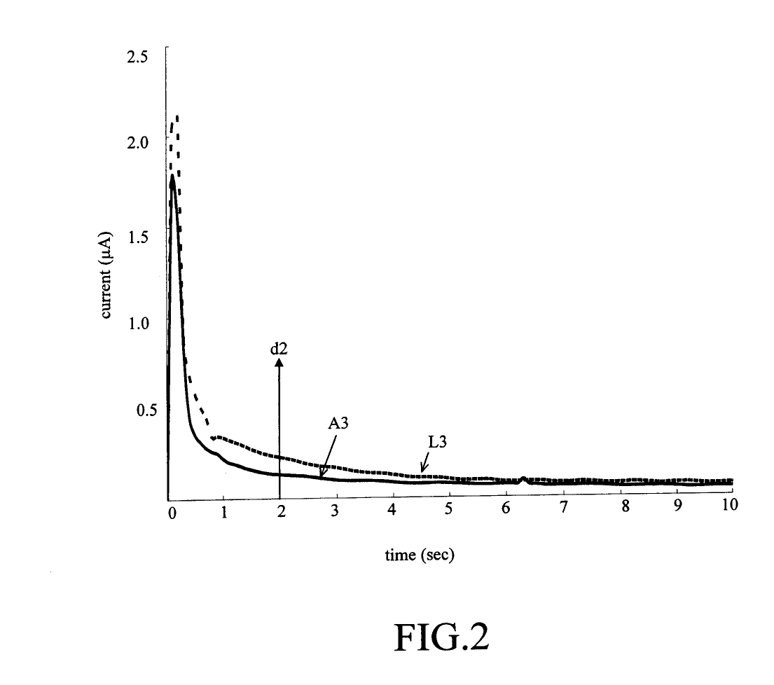

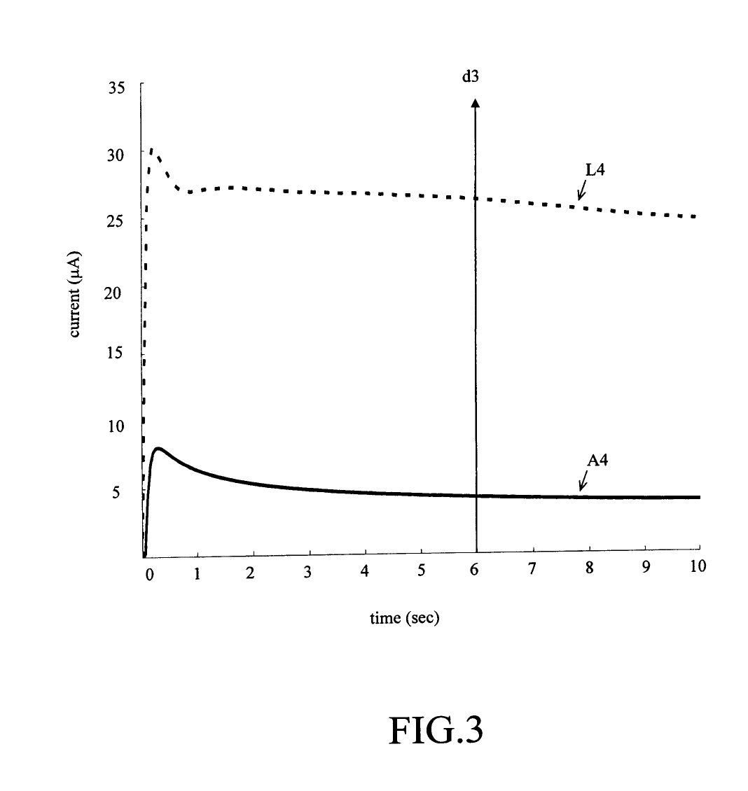

FIGS. 2 and 3 respectively depicts a current profile from the performance qualified electrochemical system showing the reaction magnitudes in association with every control solution of Examples 2B and 2C. The curves L3 and L4 represent the conventional control solutions having the amounts of lactic acid and cholesterol, respectively. The curves A3 and A4 represent the control solutions of the present invention having the amounts of lactic acid and cholesterol, respectively. Note in FIG. 2 at the detecting time d2, the current signal magnitude of the control solution for the present invention (A3) is lower than that of the conventional control solution (L3) while both of them contains the same amount of cholesterol. Also note in FIG. 3 at the detecting time d3, the current signal magnitude of the control solution for the present invention (A4) is lower than that of the conventional control solution (L4) while both of them contains the same amount of lactic acid.

### Example 3

### Glucose Control Solution with Contaminants

As aforementioned, the analyte of the control solution may decrease due to the presence of contaminants consuming the analyte, whereby resulting a wrong determination regarding the performance of the electrochemical sensing system. Example 3 demonstrates the control solution of the present invention having a higher contaminant-containing tolerance and thus the opportunity of making wrong determination is relatively reduced compared with the conventional control solution.

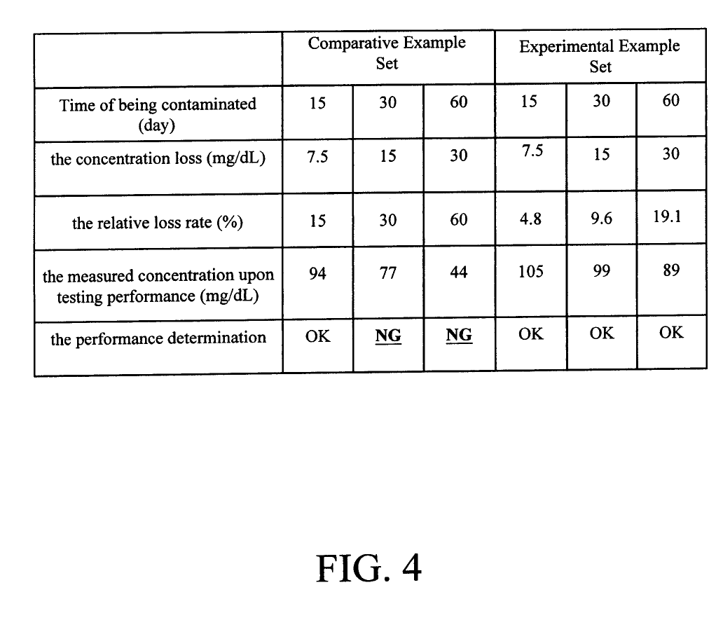

Referring to the table of FIG. 4, the comparative example set is the conventional control solution having lower glucose (CONTREX Plus), wherein the amount of glucose is 50 mg/dL before being contaminated. The measuring device is GlucoSure Star. The test strip is from GlucoSure Star containing glucose as the analyte.

Still referring to the table of FIG. 4, the standard measured concentration is ranged between 110 mg/dL±20% (i.e. between 88 mg/dL and 132 mg/dL) for the comparative example set. The experimental example set is the control solution of the present invention having an amount of glucose at 160 mg/dL and Isopropanol as an alcohol-containing adjustor at an adequate amount before being contaminated. The contaminant is glucose oxidase, for illustration not limitation. Under the performance qualified electrochemical sensing system, the control solutions of the comparative example set and the experimental example set are tested respectively at the 15^{th} day, the 30^{th} day, the 60^{th} day after being contaminated. The measured concentrations resulted from the experimental example set are 105 mg/dL, 99 mg/dL and 89 mg/dL, all of which are within the range being performance-qualified. This indicates that no wrong determination is made from the contaminated control solution of the present invention. In contrast, the measured concentrations resulted from the comparative example set are 94 mg/dL, 77 mg/dL and 44 mg/dL, wherein the 30^{th} day and the 60^{th} day are out of the range being performance-qualified. This indicates that wrong determination is made from the conventional control solution being contaminated.

Still referring to the table of FIG. 4, the concentration loss of glucose at the 15^{th} day, the 30^{th} day, the 60^{th} day is 7.5 mg/dL, 15 mg/dL and 30 mg/dL, respectively due to the daily loss is 0.5 mg/dL for these two control solutions. Based on the original amount of glucose before being contaminated, the relative loss rate of glucose is from 4.8% to 19.1% for the control solution of the present invention. In contrast, the relative loss rate of glucose for the comparative example set has been reached to 30% and 60% corresponding to the 30th day and the 60th day. As provided with higher amount of the analyte, the control solution of the present invention creates a lower relative loss rate, as such the opportunity of making a wrong determination is reduced compared with the conventional control solution.

The present invention has been described above with reference to preferred embodiments. However, those skilled in the art will understand that the scope of the present invention need not be limited to the disclosed preferred embodiments. On the contrary, it is intended to cover various modifications and equivalent arrangements within the scope defined in the following appended claims. The scope of the claims should be accorded the broadest interpretation so as to encompass all such modifications and equivalent arrangements.

1. A control solution for determining the performance of an electrochemical sensing system, the electrochemical sensing system being adapted for measuring the concentration of an analyte in a body fluid sample, the control solution comprising:
the analyte at a predetermined amount; and
an alcohol-containing adjustor, wherein the control solution generates a current signal from the electrochemical sensing system when the performance of the electrochemical sensing system is qualified and obtains a measured concentration corresponding to the current signal, wherein the measured concentration is less than a real concentration corresponding to the predetermined amount.

2. The control solution according to claim 1, wherein the electrochemical sensing system is adapted for a normal control solution having the analyte but not having the alcohol-containing adjustor, and the normal control solution generates a normal current signal from the electrochemical sensing system when the performance of the electrochemical sensing system is qualified, wherein when the control solution and the normal control solution respectively contain the same predetermined amount of a contaminate, the magnitude of the current signal for the control solution is lower than the magnitude of the normal current signal for the normal control solution.

3. The control solution according to claim 1, wherein the analyte is glucose, cholesterol, lactic acid, or triglyceride.

4. The control solution according to claim 1, wherein the alcohol-containing adjustor comprises primary alcohol, secondary alcohol, or tertiary alcohol.

5. The control solution according to claim 1, wherein the alcohol-containing adjustor is ethanol.

6. The control solution according to claim 5, wherein the concentration of ethanol is ranged between 100 ml and 500 ml based on per liter of the control solution.

7. The control solution according to claim 1, wherein the alcohol-containing adjustor is glycerol.

8. The control solution according to claim 7, wherein the concentration of glycerol is ranged between 100 ml and 500 ml based on per liter of the control solution.

9. The control solution according to claim 1, wherein the alcohol-containing adjustor is polyethylene glycol.

10. The control solution according to claim 9, wherein the concentration of polyethylene glycol is ranged between 100 g and 500 g based on per liter of the control solution.

11. The control solution according to claim 1, wherein the alcohol-containing adjustor is isopropanol.

12. The control solution according to claim 11, wherein the concentration of isopropanol is ranged between 100 ml and 500 ml based on per liter of the control solution.

13. An electrochemical sensing system for measuring the concentration of an analyte in a body fluid sample, the electrochemical system comprising:
a test strip;
a measuring device; and
a control solution according to claim 1 for determining the performance of the electrochemical sensing system.

14. A method for determining the performance of an electrochemical sensing system for measuring the concentration of an analyte in a body fluid sample, the electrochemical system comprising a test strip; a measuring device; and a control solution having an analyte at a predetermined amount and an alcohol-containing adjustor, the method comprising:
connecting the test strip to the measuring device;
generating a current signal and a measured concentration corresponding to the current signal from the measuring device by contacting the control solution with a reaction reagent on the test strip; and
determining that the electrochemical sensing system is qualified if the measuring concentration is within a standard range for the electrochemical sensing system, or determining that the electrochemical sensing system is unqualified if the measuring concentration is out of the standard range.

15. The method for determining the performance of an electrochemical sensing system according to claim 14, wherein when the electrochemical sensing system is determined qualified, the measuring concentration is less than a real concentration corresponding to the predetermined amount of the analyte.

16. The method for determining the performance of an electrochemical sensing system according to claim 14, wherein the electrochemical sensing system is adapted for a normal control solution having the analyte but not having the alcohol-containing adjustor, and the normal control solution generates a normal current signal from the electrochemical sensing system when the performance of the electrochemical sensing system is qualified, wherein when the control solution and the normal control solution respectively contain the same predetermined amount of a contaminate, the magnitude of the current signal for the control solution is lower than the magnitude of the normal current signal for the normal control solution.

17. The method for determining the performance of an electrochemical sensing system according to claim 14, wherein the analyte is glucose, cholesterol, lactic acid, or triglyceride.

18. The method for determining the performance of an electrochemical sensing system according to claim 14, wherein the alcohol-containing adjustor comprises primary alcohol, secondary alcohol, or tertiary alcohol.

19. The method for determining the performance of an electrochemical sensing system according to claim 14, wherein the alcohol-containing adjustor is ethanol.

20. The method for determining the performance of an electrochemical sensing system according to claim 19, wherein the concentration of ethanol is ranged between 100 ml and 500 ml based on per liter of the control solution.

21. The method for determining the performance of an electrochemical sensing system according to claim 14, wherein the alcohol-containing adjustor is glycerol.

22. The method for determining the performance of an electrochemical sensing system according to claim 21, wherein the concentration of glycerol is ranged between 100 ml and 500 ml based on per liter of the control solution.

23. The method for determining the performance of an electrochemical sensing system according to claim 14, wherein the alcohol-containing adjustor is polyethylene glycol.

24. The method for determining the performance of an electrochemical sensing system according to claim 23, wherein the concentration of polyethylene glycol is ranged between 100 g and 500 g based on per liter of the control solution.

25. The method for determining the performance of an electrochemical sensing system according to claim 14, wherein the alcohol-containing adjustor is isopropanol.

26. The method for determining the performance of an electrochemical sensing system according to claim 25, wherein the concentration of isopropanol is ranged between 100 ml and 500 ml based on per liter of the control solution.
